(19) United States
(12) Patent Application Publication
(10) Pub. No.: US 2019/0057352 A1
(43) Pub. Date: Feb. 21, 2019

(54) Unmanned Aerial Vehicle Courier Service with Mobile Device Traffic Management Application and Identified User Landing Pads

(71) Applicant: HADIF HAMAD ALMHEIRI, Sharjah (AE)

(72) Inventor: HADIF HAMAD ALMHEIRI, Sharjah (AE)

(21) Appl. No.: 16/049,810

(22) Filed: Jul. 31, 2018

Related U.S. Application Data
(60) Provisional application No. 62/546,556, filed on Aug. 17, 2017.

(51) Int. Cl. G06Q 10/08; H04L 29/12; G08G 5/00

(52) U.S. Cl. CPC G06Q 10/08355; H04L 61/2007; H04L 67/10; G08G 5/0069; G08G 5/0056; G08G 5/003

(57) ABSTRACT

An unmanned aerial vehicle courier service with mobile device traffic management application and identified user landing pads is disclosed. The invention comprised of a landing pad and software application for mobile devices having dashboards for a variety of stakeholders such end user subscribers, courier services and operations team. The aforementioned landing pads and software services allow users to schedule a pickup and delivery, reserve a flight path, track a package and detect UAV arrivals and departures. An object of the invention is to allow greater, open access to UAV delivery methods for common citizens and residents of a community.

### CROSS-REFERENCE TO RELATED APPLICATIONS

The present application claims priority to U.S. Provisional Patent Application Ser. No. 62/546,556, filed on Aug. 17, 2017 entitled “An Unmanned Aerial Vehicle Courier Service with Mobile Device Traffic Management Application and Identified User Landing Pads”, the disclosure of which is hereby incorporated in its entirety at least by reference.

### FIELD OF THE INVENTION

The present invention generally relates to unmanned aerial vehicles (UAVs). More specifically it relates to a UAV cornier system with mobile device application software and flight path management system.

### BACKGROUND

Unmanned Aerial Vehicles (UAV), also referred to as vertical takeoff and landing vehicles and drones, have become increasingly popular after being adopted by military services and by recreational enthusiasts over the past several decades. UAVs continue to offer a growing array of functionality not found in other forms of large, rotorcraft and winged aircraft, including aerial photography, visual surveillance, remote sensing, crop spraying and a host of other uniquely-suited operations. Many large industries have begun aligning themselves with drone services, including popular retailers such as Walmart™ and Amazon™. While many of these companies have patented UAV traffic monitoring systems, few incorporate landing and launch pads owned by customers that have unique, Internet Protocol addresses (IP Addresses) that interact with mobile device applications through a cloud-based network to monitor and control UAV traffic.

### SUMMARY OF THE INVENTION

The device herein disclosed and described provides a solution to the shortcomings in the prior art through the disclosure of an unmanned aerial vehicle courier service with mobile device traffic management application and identified user landing pads. An object of the invention is to provide residents of a community with individual UAV landing pads connected to a cloud-based network that allows homeowners and apartment dwellers alike greater access to personal UAV courier services.

Another object of the invention is to provide UAV landing pads with a unique IP address tied into mapping applications and GPS coordinates. Having individual identifiers allows landing pads to be located in densely populated areas and allows UAVs to locate addresses automatically.

Another object of the invention is to provide a UAV software application for mobile devices allowing users to connect their landing pad to a cloud network and request courier services. Users can request a delivery and an available UAV will automatically arrive at the landing pad for delivery. Said UAVs can be contracted from other participants and users can even commit their own drone to perform courier duties using the application. Said application also performs a host of administrative tasks such as delivery tracking, delivery confirmation as well as membership services.

Another object of the invention is to provide a UAV management service for the software application that includes a multitude of services to subscribers such as: allowing users to reserve flight paths for deliveries, providing UAV and rerouting procedures in emergencies, overseeing security for UAVs and their cargo. For example, a user may report a suspicious package on a UAV and send an alert via text message to the management support team using application software 4 who can then reroute the UAV to a safe location for inspection—such an inspection may also involve local law enforcement in extreme cases. The management support team also has the capability to intervene any participating UAV and terminate its flight during an emergency such as an engine failure etc.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as limitations thereon.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a perspective view of the landing pad of the invention.

FIG. 2 is a perspective view of the invention's software application.

FIG. 3 is a perspective view of the traffic management service.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

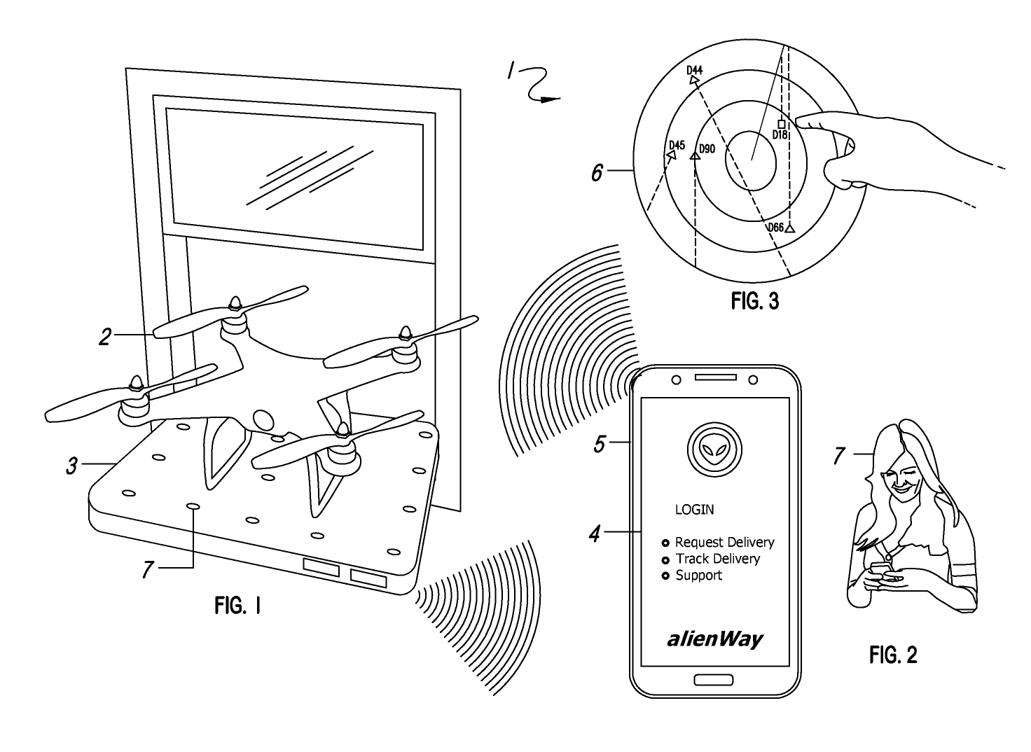

FIG. 1 showing a perspective view of the invention 1 having a rectangular-shaped landing pad 3 comprised of a square-shaped, planar pad made of a rigid material such as plastic and the like having a power source, an internal microprocessor (such as a programmable logic controller, Arduino™ and the like), internal buffer memory and wireless transmitter such as, but not limited to WiFI and BlueTooth™. Said invention also having a dedicated internet protocol identification and being capable of interacting with mobile devices, computers and cloud networks and having a bracing system on a lower side allowing for a plurality of different UAVs types with heavy payloads. FIG. 1 also showing a typical UAV (or quadcopter etc.) perched on said landing pad 3 installed on a typical window sill. Said landing pad also sending out signals of its IP address and having a multitude of light emitting diodes (LEDs) 7 on an upper portion that detect the presence of a UAV that has landed or taken off and notifying a user via mobile device 5 thereof.

FIG. 2 is a front view of invention 1 having a software application 4 residing on a mobile device 5. Said software 4 comprised of, but not limited to, Java™, C+ and the like and compatible with a plurality of mobile device and computer operating systems, such as Windows™, Apple™, Google™, Android™ etc. Said software application 4 having a multitude of secure logins and dashboards for several stakeholders, including residential end users 7, courier services, and management support team. Functions of software application 4 embodiment for end users 7 including, but not limited to: registering subscribers 7 and landing pads 3, connecting said landing pads 3 to a cloud network platform and existing global positioning systems (such as Google Earth™, ESRI™, Trimble™ etc.), allowing courier requests from participating vendors, tracking deliveries in real time, delivery confirmations and landing pad-to landing pad requests, online courier payments, package arrival and departure notifications etc. Functions of software application 4 embodiment for courier services including, but not limited to: scheduling deliveries, tracking re-usable supplying UAVs with transport bins having individualized tracking codes, receiving electronic payments and customer support interactions.

FIG. 3. showing a front view of one of the software application 4 embodiments for management support team and illustrates flight paths 6 reserved for UAV delivery requests. Said management support team coordinating and confirming airspace for delivery services between a user 7 and a courier service. Other management support team functions include, but are not limited to, providing field maintenance to UAVs in the field and overseeing security of packages and UAVs themselves.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. An UAV courier service with mobile device traffic management application and identified user landing pads.

2. The UAV courier service with mobile device traffic management application and identified user landing pads of claim 1 providing a community with individual landing pads connected to a cloud-based network that allows homeowners and apartment dwellers alike greater access to personal UAV courier services

3. The UAV courier service with mobile device traffic management application and identified user landing pads of claim 1 providing UAV landing pads with a unique IP address tied into mapping applications and GPS coordinates.

4. The UAV courier service with mobile device traffic management application and identified user landing pads of claim 1 providing a software application for mobile devices allowing users to connect their landing pad to a cloud network and request courier services.

5. The UAV courier service with mobile device traffic management application and identified user landing pads of claim 1 providing an UAV management service for the software application that includes a multitude of services to subscribers such as: allowing users to reserve flight paths for deliveries, providing UAV and rerouting procedures in emergencies, overseeing security for UAVs and their cargo etc.
